(19) United States
(12) Patent Application Publication
(10) Pub. No.: US 2005/0113131 A1
(43) Pub. Date: May 26, 2005

(54) Bluetooth earphone for measuring body temperature

(76) Inventors: Chih-Lung Lin, Sinying City (TW); Tzung-Yuan Yang, Taipei City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/993,193

(22) Filed: Nov. 19, 2004

(30) Foreign Application Priority Data
Nov. 21, 2003 (TW) 92132841

(51) Int. Cl. H04B 7/00; H04M 1/00

(52) U.S. Cl. 455/550.1; 455/556.1; 455/41.2

(57) ABSTRACT

A Bluetooth earphone device for measuring body temperature is provided. The body temperature value measured by the Bluetooth earphone device is transmitted to a database where the body temperature value can be stored. After having measuring a body temperature according to a start command issued by a local Bluetooth device, the Bluetooth earphone transmits the body temperature value back to the local Bluetooth device to be stored therein. The local Bluetooth device can transmit the data to a database to facilitate central management of data. The Bluetooth earphone device includes a temperature sensor, a display and a Bluetooth module. The Bluetooth module includes a micro-controller and a memory. When a user wears the Bluetooth earphone device, the temperature sensor produces a body temperature signal according to the user's body temperature. The body temperature signal is used to calculate the body temperature value corresponding to the user's body temperature.

This application claims the benefit of Taiwan application Serial No. 92132841, filed Nov. 21, 2003, the subject matter of which is incorporated herein by reference.

### BACKGROUND OF THE INVENTION

1. Field of the Invention

The invention relates to a body temperature-measuring device, and more particularly, relates to a Bluetooth earphone system with body temperature measuring device.

2. Description of the Related Art

In recent years, various epidemic diseases are spreading widely and have become a severe threat to the health of mankind. In order to effectively scrutinize potential carriers of infectious viruses or bacteria, body temperature measuring centers or scrutinizing stations are set up at many high-density public places such as office buildings or hospitals to measure visitors' temperatures. Due to the fact that the operator of the most commonly used infrared thermometer has to carry a thermometer at hand when measuring the temperature and can only measure a person's temperature at a time, a long queue will be formed during rush hours. This is indeed a waste of time for the visitors.

According to the current practice of temperature measuring, a person to be measured is passively asked to have his or her temperature measured and recorded by others, a temperature measurer for instance. This task, which is an extra workload for the employers who are already busy to cope with, will even affect the employee-employer relations.

Moreover, an office building is normally stationed by several companies, which also require their staff's temperature data. Due to limited resources, the measurer stationing at the entrance can only scrutinize potential carriers and will be unable to categorize the temperature data of the staff according to their departments and companies and dispatch the temperature data to the directors of respective departments. Nevertheless, this is already too busy for quarantine inspectors to cope with.

More importantly, one-person-one-probe cover policy to avoid infection is impractical in overcrowded occasions. In reality, everyone is under the risk of getting infected via a shared probe cover. The policy of measuring body temperature to avoid infection is itself a path of infection.

### SUMMARY OF THE INVENTION

It is therefore, an object of the invention to provide to a Bluetooth earphone system with body temperature measuring function. The person who is equipped with the system can automatically have his or her temperature measured and reported to his or her workplace, not only simplifying the required procedures and labor of measuring body temperature, but also effectively preventing infection.

The invention achieves the above-identified object by providing a Bluetooth earphone system with body temperature function disclosed below.

The Bluetooth earphone system with body temperature function transmits a body temperature value measured by a Bluetooth earphone to a database where the body temperature value is stored via a local Bluetooth device. After having measured a body temperature according to a start command issued by a local Bluetooth device, the Bluetooth earphone transmits the body temperature value back to the local Bluetooth device to be stored therein. Meanwhile, the local Bluetooth device can transmit the data to a database through a transmission interface to facilitate central management of data. The Bluetooth earphone device includes a temperature sensor, a display and a Bluetooth module. The Bluetooth module includes a micro-controller and a memory. When a user wears the Bluetooth earphone device, the temperature sensor produces a body temperature signal according to the user's body temperature, wherein the temperature sensor calculates the body temperature value corresponding to the user's body temperature according to the body temperature signal. The body temperature value can be stored in the memory or shown in the display for the user's reference. On the other hand, the micro-controller can send the body temperature value stored in the memory to a local Bluetooth device, which in turn transmits the data to a database to be stored therein via a transmission interface.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a Bluetooth earphone system with body temperature measuring function according to a preferred embodiment of the invention;

FIG. 2 is a block diagram of a Bluetooth earphone with body temperature measuring function;

FIG. 3 is a flowchart showing the method of measuring body temperature by a Bluetooth earphone;

FIG. 4 shows the setting process of a Bluetooth mobile phone; and

FIG. 5 is the body temperature measuring process of the Bluetooth earphone system.

### DETAILED DESCRIPTION OF THE INVENTION

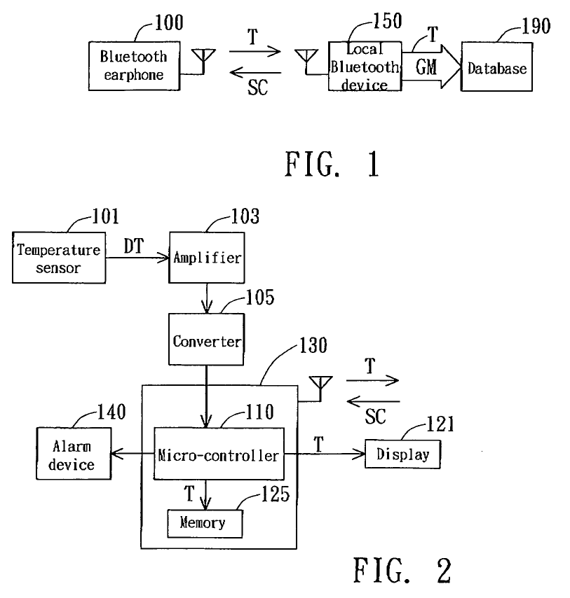

Referring to FIG. 1, a schematic diagram of a Bluetooth earphone system with body temperature measuring function according to a preferred embodiment of the invention is shown. When the user puts a Bluetooth earphone 100 on the head, the Bluetooth earphone 100 will first of all use its built-in body temperature function to measure a body temperature value T, then transmit the measured body temperature value T to a local Bluetooth device 150 via a Bluetooth system and have the body temperature value T transmitted to a database 190 and stored therein via a transmission interface GM. The local Bluetooth device 150 can be a Bluetooth mobile or a personal computer equipped with a Bluetooth module.

For example, the user can incorporate the Bluetooth earphone 100 with a Bluetooth mobile phone. Meanwhile, the local Bluetooth device 150 is a Bluetooth mobile phone. After the Bluetooth earphone 100 transmits the body temperature value T to the Bluetooth mobile phone, the Bluetooth mobile phone will start to be connected to the database 190 and store the body temperature value T to the database 190 after the connection is established, wherein the transmission interface between the Bluetooth mobile phone and the database 190 can be a general packet radio service (GPRS), GSM or CDMA. However, the application of the above structure is not limited to the Bluetooth mobile phone; the body temperature value T can be transmitted to the database 190 via a personal computer equipped with a Bluetooth module. Under such structure, the transmission interface between the personal computer and the database 190 can a local network interface or a wireless network interface.

It is noteworthy that the local Bluetooth device 150 can automatically send out a start command SC for the Bluetooth earphone 100 to start with the process of measuring body temperature rather than passively receives the body temperature value T to be inputted by the Bluetooth earphone 100 to start with a process. Take the application of the Bluetooth mobile phone for example, a department director can choose to send a text message of measuring body temperature to the colleagues. After having received the text message, the mobile phone will issue a start command SC activating the Bluetooth earphone 100 to measure the body temperature. So the body temperature data of all the staff can be filed in a short time with high efficiency.

Referring to FIG. 2, a block diagram of a Bluetooth earphone with body temperature measuring function is shown. The Bluetooth earphone 100 includes a temperature sensor 101, an amplifier 103, a converter 105, a display 121, a Bluetooth module 130 and an alarm device 140. The Bluetooth module 130 includes a micro-controller 110 and a memory 125; the converter 105 can be an analog to digit converter (ADC); the alarm device 140 can be a speaker. When the user wears the Bluetooth earphone 100, the temperature sensor 101 will produce a temperature signal DT according to the body temperature of the user. After being amplified by the amplifier 103 and converted by the converter 105, the analog body temperature signal DT will become a digital signal. After the micro-controller 110 calculates the converted body temperature signal DT, the micro-controller 110 will obtain a body temperature value T corresponding to the body temperature and store the body temperature value T in the memory 125 which can be shown on the display 121 for the user's reference.

On the other hand, the micro-controller 110 can also control the Bluetooth module 130 to send out the body temperature value T stored in the memory 125. In practical application, the user can pre-set a temperature threshold, say, 39° C. for instance. When the body temperature value T exceeds the temperature threshold, a fever is indicated. Meanwhile, the micro-controller 110 makes the alarm device 140 send out a warning signal, for example sound, to remind the user.

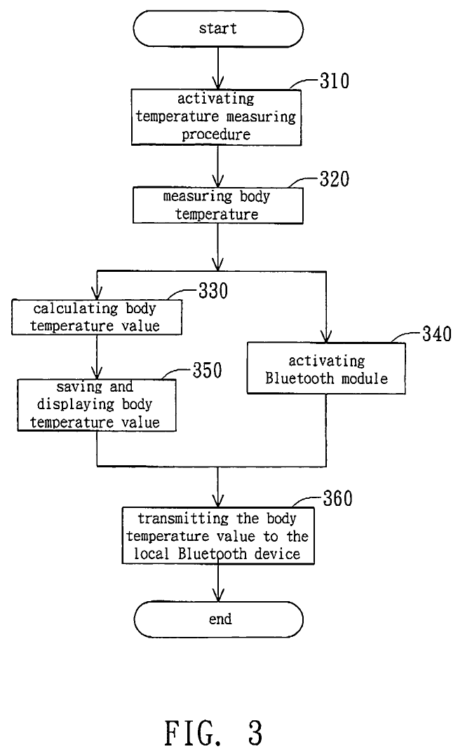

Referring to FIG. 3, a flowchart showing the method of measuring body temperature by a Bluetooth earphone is shown. First of all, a Bluetooth earphone activates a temperature measuring procedure according to the start command inputted by a local Bluetooth device (step 310). Next, generating a corresponding body temperature signal of a body temperature measured by a temperature sensor (step 320). After that, amplify and digitalize the body temperature signal for a micro-controller to calculate a body temperature value, and then store the body temperature value in a memory and further display the result for the user's reference (step 330, 350). On the other hand, the stand-by function of the Bluetooth module is activated during the measuring of body temperature (step 340). After the body temperature value is obtained, the Bluetooth earphone uses the Bluetooth module to transmit the body temperature value to a local Bluetooth device, which in turn transmits the body temperature value to a database to be filed therein (step 360).

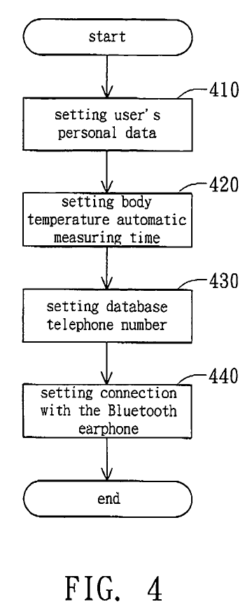

Referring to FIG. 4, a setting process of a Bluetooth mobile phone is shown. The setting process is to be incorporated with the body measuring function of a Bluetooth earphone. The user can pre-set his or her personal data such as name, address, etc (step 410). Set the mobile phone to send a start command at a certain time to activate the Bluetooth earphone to execute body temperature measuring (step 420). Besides, the user needs to build-in the telephone number of the company's database center, so that after receiving the body temperature value, mobile phone is connected to the database and transmits the body temperature to the data base (step 430). Most importantly is the step of setting connection with the Bluetooth earphone to obtain the body temperature value (step 440).

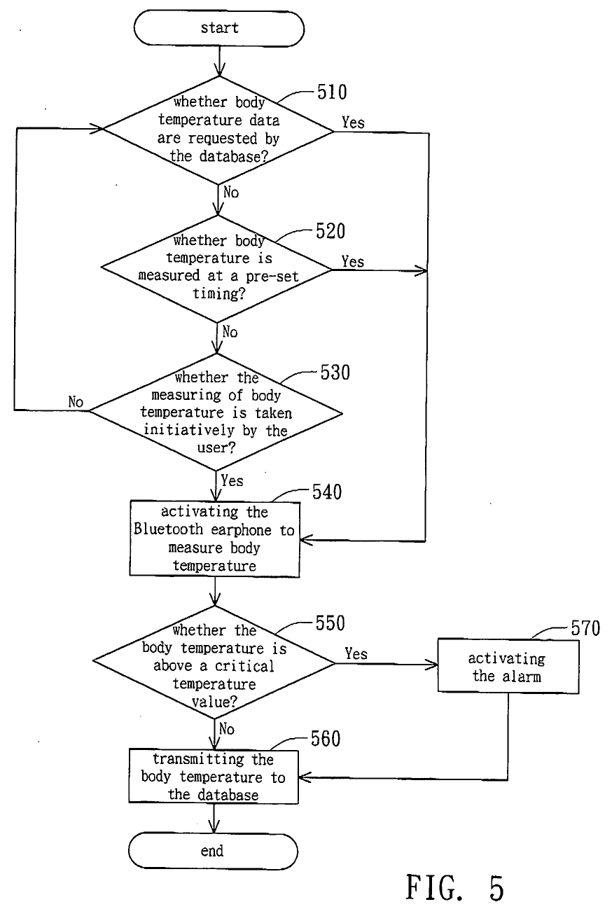

Referring to FIG. 5, a flowchart showing the body temperature measuring process of the Bluetooth earphone system. In practical application, the invention provides three ways of activating the measuring of body temperature. First: the database can send a command of measuring body temperature to a local Bluetooth device; for example, the message of measuring body temperature can be broadcasted to relevant personnel if staff's body temperature data are requested by their director, so that the body temperature can be measured (step 510). Second: the mobile phone automatically activates a pre-set timing for the Bluetooth earphone to measure body temperature (step 520). Third: the function of the measuring of body temperature and reporting the measured body temperature value accordingly is set to be manual (step 530). If any of the three steps holds true, the Bluetooth earphone will be activated to calculate and transmit the body temperature value to the database (step 40, 560). If the body temperature value exceeds a temperature threshold (when the outcome is affirmative in step 550), then the Bluetooth earphone will activate an alarm device to warn the user (step 570) and transmit the body temperature value to the database to be filed therein step 570).

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A Bluetooth earphone system with body temperature measuring function for measuring a body temperature and transmitting the measured value to a database, the Bluetooth earphone system comprising:
a local Bluetooth device having a transmission interface for connecting to the database and sending a start command to measure the body temperature; and
a Bluetooth earphone for measuring the body temperature according to the start command, the Bluetooth earphone comprising:
a temperature sensor for outputting a body temperature signal according to the body temperature; and
a Bluetooth module coupled to the temperature sensor, outputting a body temperature value corresponding to the body temperature signal to the local Bluetooth device;
wherein after receiving the body temperature value, the local Bluetooth device is connected to the database and transmits the body temperature value to the database.

2. The Bluetooth earphone system according to claim 1, wherein the Bluetooth module further comprises a micro-controller and a memory, the body temperature value is generated after the body temperature signal is processed by the micro-controller, which further stores the body temperature value in the memory.

3. The Bluetooth earphone system according to claim 2, wherein the Bluetooth earphone further comprises an alarm device coupled to the micro-controller, when the body temperature value exceeds a temperature threshold, the micro-controller makes the alarm device send out a warning signal.

4. The Bluetooth earphone system according to claim 3, wherein the temperature threshold is set by the micro-controller.

5. The Bluetooth earphone system according to claim 1, wherein the local Bluetooth device is a Bluetooth mobile communication device.

6. The Bluetooth earphone system according to claim 1, wherein the local Bluetooth device is a computer system equipped with a Bluetooth module.

7. The Bluetooth earphone system according to claim 6, wherein the transmission interface is a local network interface.

8. The Bluetooth earphone system according to claim 6, wherein the transmission interface is a wireless network interface

9. The Bluetooth earphone system according to claim 1, wherein the Bluetooth earphone system further comprises a display coupled to the micro-controller for displaying the body temperature value.

10. A method of measuring and transmitting body temperature applicable to a Bluetooth earphone system for measuring a body temperature, the Bluetooth earphone system comprising a Bluetooth earphone and a local Bluetooth device, the local Bluetooth device being connected to a database, the method comprising:
a. activating the Bluetooth earphone by the local Bluetooth device to measure the body temperature;
b. outputting a body temperature value corresponding to the body temperature to the local Bluetooth device by the Bluetooth earphone; and
c. the local Bluetooth device connecting with the database for transmitting the body temperature value thereto after receiving the body temperature value.

11. The method of measuring and transmitting body temperature according to claim 10, wherein the method further comprises:
enabling the Bluetooth earphone to send out a warning signal when the body temperature value exceeds a temperature threshold.

12. The method of measuring and transmitting body temperature according to claim 10, wherein the method further comprises:
m. determining whether the body temperature value is requested by the database, if so, proceeding to step a, otherwise, proceeding to step n;
n. determining whether a pre-set timing for the function of measuring body temperature is activated, if so, proceeding to step a, otherwise, proceeding to step p; and
p. determining whether the function of the measuring of body temperature is set to be manual, if so, proceeding to step a, otherwise, proceeding to step m.

13. The method of measuring and transmitting body temperature according to claim 12, wherein the method further comprises:
enabling the Bluetooth earphone to send out a warning signal when the body temperature exceeds a temperature threshold.
